(19) United States
(12) Patent Application Publication
(10) Pub. No.: US 2011/0181396 A1
(43) Pub. Date: Jul. 28, 2011

(54) RFID INFORMATION DATA ON EXTERNAL MEMORY

(76) Inventor: Ralph Hilla, JR., Burnsville, MN (US)

(21) Appl. No.: 13/012,216

(22) Filed: Jan. 24, 2011

Related U.S. Application Data
(60) Provisional application No. 61/336,584, filed on Jan. 25, 2010.

(51) Int. Cl. G06K 7/01

(52) U.S. Cl. 340/10.1

(57) ABSTRACT

A computer operating system runs a computer. The computer operating system executes a computerized method including sending an RF signal to an external memory device, eliciting and receiving an input from the external memory device that identifies the external device and a set of files stored on the external memory device, and displaying the set of files on a display device of a computer. The external memory device can be any device with a memory, such as a thumb drive, camera, or the like.

### CROSS-REFERENCE TO RELATED APPLICATIONS

This application claims the benefits of the filing date of U.S. Provisional Patent Application Ser. No. 61/336,584 that was filed Jan. 25, 2010, which is entitled “RFID Information Data On External. Memory” which is hereby incorporated herein in its entirety by reference.

### FIELD OF THE INVENTION

Disclosed is a method and apparatus for identifying information and data stored on external memory devices. More specifically, an apparatus is used to implement a scheme using to help identify what data is on external memory devices.

### BACKGROUND

External memory devices, such as jump' drives that are plugged and unplugged onto connectors, such as the ‘USB’ connector on a personal computer, are growing in popularity as well as capacity. That means that more and more items of data are being stored onto each of these devices. These memory devices are also becoming very popular for ‘permanent’ storage for items, such as; music, pictures, medical, financial, business. Hence, any person may own quite a few of these devices with each one easily holding data in the gigabyte range. Currently, these external memory devices have capacities generally in the range of 2-32 gigabytes. Some external memory devices have a capacity in excess of 32 gigabytes. It is anticipated that the capacity of these devices will continue to grow. Many people will have multiple “jump” drives for storing various data. An executive may even carry multiple external drives in his or her briefcase. For that person to remember which device has what data is becoming increasingly difficult. To add to the problem, these memory devices are physically small. That means there is not sufficient room to write a note on them describe all of the data that is installed on any particular device. The only current way for a person to determine what data is on a device, is to plug the device onto a USB connector or other connector, such as is on a computer, and bring up the software and read the files and folders. This is slow and cumbersome process.

### BRIEF DESCRIPTION OF THE DRAWINGS

FIG. 1 is diagrammatic representation of a computing device for a machine in the example electronic form of a computer system, within which a set of instructions for causing the machine to perform any of a number of methodologies for operation of an RFID system, according to an example embodiment.

FIG. 2 is a schematic diagram of a computing system that includes a plurality of modules, according to an example embodiment.

FIG. 3 is a schematic diagram of an RFID system, according to an example embodiment.

FIG. 4 is a schematic diagram of an RFID tag, according to another example embodiment

FIG. 5 is a schematic diagram showing an RFID tag that includes a first tag portion and a second tag portion, according to an example embodiment.

FIG. 6 is phase shifted waveform, such as a modulated RF signal, with three possible choices for a mark for a phase lock loop AND/OR gate, according to an example embodiment.

FIG. 7 is a diagram showing data transfer in eight byte segments between the timing marks, according to an example embodiment.

FIG. 8 is a diagram showing data transfer in eight byte segments along with transfer of a three byte instruction between floating timing marks, according to an example embodiment

FIG. 9 is an instruction and password set, according to an example embodiment.

### DESCRIPTION OF THE INVENTION

All Figures are illustrated for ease of explanation of the basic teachings of the present invention only; the extensions of the Figures with respect to number, position, relationship and dimensions of the parts to form one embodiment of the invention that will be explained or will be within the skill of the art after the following description has been read and understood. Further, the exact dimensions and dimensional proportions to conform to specific force, weight, strength, and similar requirements for various applications will likewise be within the skill of the art after the following description has been read and understood. The dimensions described will not be critical to the invention.

Where used in various Figures of the drawings, the same numerals designate the same or similar parts. Furthermore, when the terms “top,” “bottom,” “right,” “left,” “front,” “rear,” “first,” “second,” “inside,” “outside,” and similar terms are used, the terms should be understood to reference only the structure shown in the drawings and utilized only to facilitate describing the illustrated embodiments.

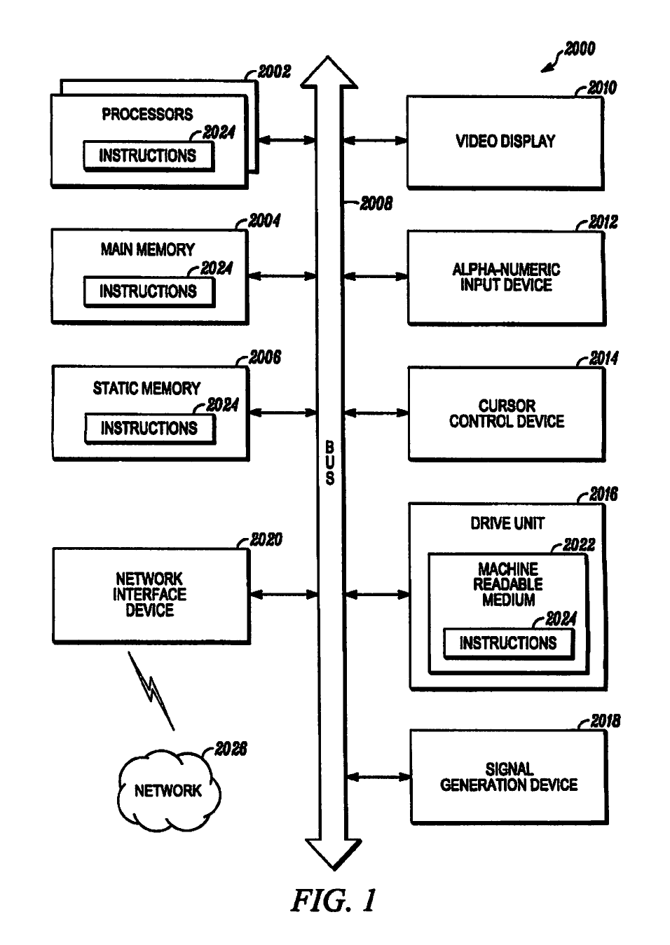

FIG. 1 shows a diagrammatic representation of a computing device for a machine in the example electronic form of a computer system 2000, within which a set of instructions for causing the machine to perform any one or more methodologies discussed herein can be executed or is adapted to include the apparatus for RFID reading, as described herein. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a digital camera, a portable music player (e.g., a portable hard drive audio device such as an Moving Picture Experts Group Audio Layer 3 (MP3) player, a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor or multiple processors 2002 (e.g., a central processing unit (CPU), a graphics processing unit (GPU), arithmetic logic unit or all), and a main memory 2004 and a static memory 2006, which communicate with each other via a bus 2008. The computer system 2000 can further include a video display unit 2010 (e.g., a liquid crystal displays (LCD) or a cathode ray tube (CRT)). The computer system 2000 can also include an alphanumeric input device 2012 (e.g., a keyboard), a cursor control device 2014 (e.g., a mouse), a disk drive unit 2016, a signal generation device 2018 (e.g., a speaker) and a network interface device 2020.

The disk drive unit 2016 includes a computer-readable medium 2022 on which is stored one or more sets of instructions and data structures (e.g., instructions 2024) embodying or utilized by any one or more of the methodologies or functions described herein. The instructions 2024 can also reside, completely or at least partially, within the main memory 2004 and/or within the processors 2002 during execution thereof by the computer system 2000. The main memory 2004 and the processors 2002 also constitute machine-readable media.

The instructions 2024 can further be transmitted or received over a network 2026 via the network interface device 2020 utilizing any one of a number of well-known transfer protocols (e.g., Hyper Text Transfer Protocol (HTTP), CAN, Serial, or Modbus).

While the computer-readable medium 2022 is shown in an example embodiment to be a single medium, the term “computer-readable medium” should be taken to include a single medium or multiple media (e.g., a centralized or distributed database, and/or associated caches and servers) that store the one or more sets of instructions and provide the instructions in a computer readable form. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, tangible forms and signals that can be read or sensed by a computer. Such media can also include, without limitation, hard disks, floppy disks, flash memory cards, digital video disks, random access memory (RAMs), read only memory (ROMs), and the like.

The example embodiments described herein can be implemented in an operating environment comprising computer-executable instructions (e.g., software) installed on a computer, in hardware, or in a combination of software and hardware. Modules as used herein can be hardware or hardware including circuitry to execute instructions. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method(s) can be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

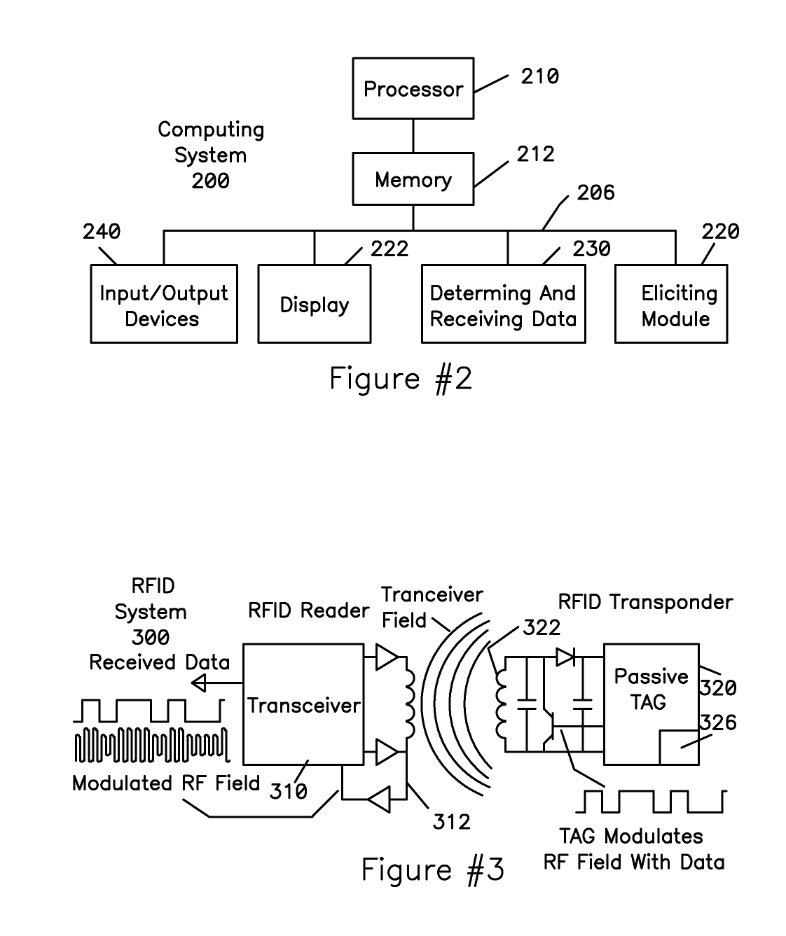

FIG. 2 is another schematic diagram of a computing system 200 that includes a plurality of modules, according to an example embodiment. In one example embodiment, the computing system 200 is formed using at least the central processing unit 2002 and the memory 2004, 2006 of the computer system 2000, as shown in FIG. 1. The memory 212 of the computer system 200 is used to store machine-readable instructions. The central processing unit 210 acts in accord with the computer-readable instructions to form the various modules, according to an embodiment of the invention. In one embodiment, the computing system 200 includes an input/output device 240. The system 200 also includes an eliciting module 220. The eliciting module 220 commands or prompts an input/output device 240 to send a signal to elicit data from another device. The computing system also includes a receiving and determining data module 230. The receiving and determining data module 230 receives signals and decodes them to determine the data. Of course, a computing system 200 can have a plurality of input output devices 240. In one example embodiment, the computing system includes an RFID reader 310 (shown in FIG. 3) as an input/output device 240. The RFID reader 310, in one embodiment, includes an eliciting module 220 and includes a receiving and determining data module 230. The RFID reader can include these modules, or can use any portion of these modules 220, 230 that are associated with the computer system 200. In other words, the computer system 200 can have these modules 220, 230 and the RFID reader 310 can have separate modules 220, 230. In another embodiment, an RFID reader can use all or a portion of these modules 220, 230 associated with the computing system 200.

FIG. 3 shows a schematic diagram of an RFID system 300, according to an example embodiment. The RFID system 300 includes the RFID reader 310, and an RFID tag 320. RFID reader 310 includes an antenna 312 which broadcasts or produces electromagnetic energy. Some refer to the broadcast or production of electromagnetic energy as an interrogation signal. In response to the broadcast or electromagnetic energy, a radio signal is produced at the RFID tag 320. The radio signal is received at the antenna 312 by the RFID reader 310. The received radio signal 400 includes data. The data is carried by the radio signal. The RF field of the received radio signal is modulated with the data. RFID reader 310 receives and decodes the radio signal to get the data. The RFID tag includes an antenna 322, and a coil 324. The electromagnetic field produced by the RFID reader 310 is received by the antenna 322 and the coil 324 of the RFID tag. The RFID tag 320 uses power harvested from the electromagnetic coil or power from a power source, such as an internal battery, and sends radio frequency waves modulated with data back to the RFID reader 310. The RFID tag 320 shown in FIG. 3 can be a passive tag, an active tag or a semi passive tag. Each type of RFID tag 320 includes a memory 326. The memory can be on board the RFID tag 320 or can be accessed from a device to which the RFID tag 320 is attached. In other words, the memory for the RFID tag 320 can be a separate memory module used only for the RFID tag, or can be a portion of a larger memory device to which the RFID tag 320 has access.

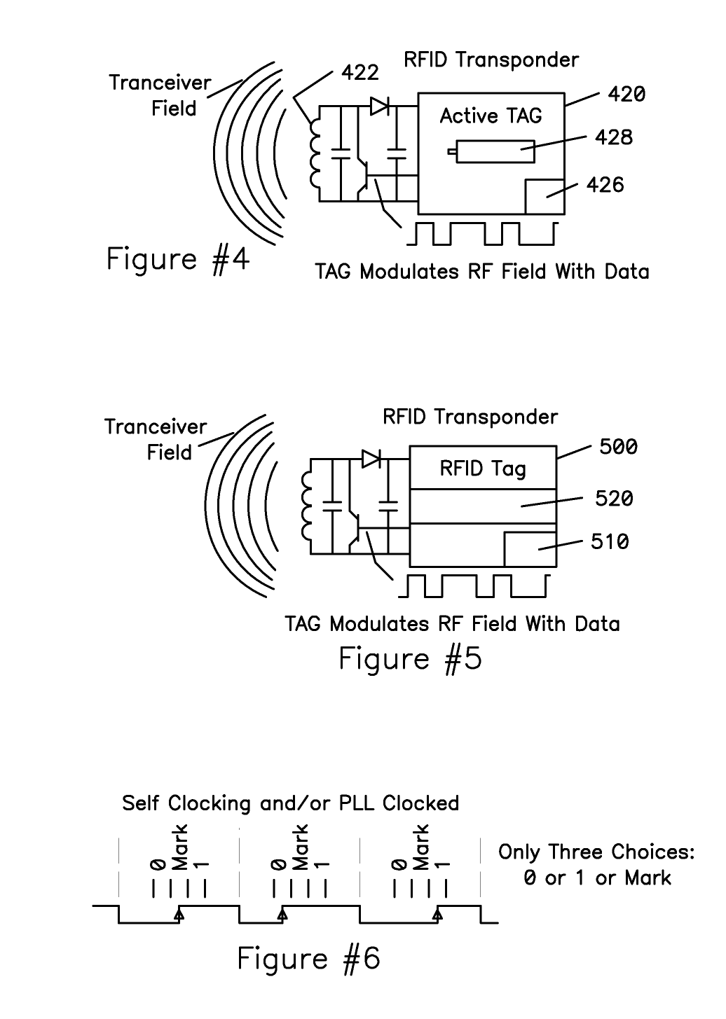

FIG. 4 is a schematic of an RFID tag 420 that is active. The active RFID tag 420 also includes a memory 426. The active RFID tag 420 also includes a battery 428 used to power the circuit of the RFID tag 420 and to broadcast of modulated radio waves that carry information related to data. An active RFID tag contains more hardware than a passive tag and therefore tends to be more expensive than a passive RFID tag 320 of FIG. 3. Active RFID tags generally have a greater range over which the radio waves can be transmitted. The active RFID tag 420 also may include a larger physical memory.

Semi passive RFID tags also include a battery. Generally, the battery is used to power the RFID circuit. The semi passive RFID tag scavenges power from the electomagnetic energy sent by the RFID reader 310, discussed and shown in FIG. 3. It should be noted that different types of RFID tags 320, 420 can be used in different applications. For example, active and semi passive RFID tags broadcast high frequencies from 850 to 950 MHz that can be read 100 feet or more away. Furthermore, if an application requires reading the tags from even farther away, additional batteries can boost a tag's range to over 300 feet (100 meters). By contrast, passive RFID tags rely entirely on the reader as their power source. These tags are read up to 20 feet away, and they have lower production costs, meaning that they can be used for less expensive applications or in applications where lower costs are desired.

No matter what type of RFID tag is used, the memory used must be read-write memory. In this way, the data stored in the memory 326, 426 can be changed or updated. It is contemplated that an RFID tag 320, 420 be associated with a device that includes a memory of its own. In one embodiment, the RFID tag 320, 420 is associated or electrically attached to a memory device, such as a jump drive, thumb drive, or stick memory. It is also contemplated that an RFID tag 320, 420 could also be associated with other types of portable memory, such as CompactFlash, Secure Digital, xD Memory Cards, or the like. This type of memory can be used with many types of consumer devices, such as cameras.

In operation, the information or data transmitted by the RFID tag 320, 420 will include a first portion that identifies the device as well as a second portion that further identifies what is stored on the device. In one embodiment, the second portion of the data transmitted includes the file names of the files stored in the portable memory, such as CompactFlash, Secure Digital, xD Memory Cards, or the like. In another embodiment, the second portion of the data transmitted includes file names and file types. In yet another embodiment, the second portion of data transmitted includes a file directory of the files stored on the portable memory device. Such a file directory might include folders and subfolders in which the files are stored. In this way, a user can quickly review the contents of several devices having memory therein or which have the primary purpose of storage of data. For example, a business executive can carry multiple stick memory devices or jump drives in a brief case. Inevitably, the user will know that one of the multiple memory devices includes a file being sought. The user may not remember exactly which memory device holds the file being sought. The user can quickly review each of the memory devices to see what files are on each memory device. Once the file is found, the memory device, such as a jump drive or memory stick, can be plugged into a universal serial bus port or the like and connected to computer system 200 to read the file.

In one embodiment, an RFID tag is not provided with a separate memory device. Rather, a portion of the memory associated with the memory device is devoted or dedicated for use by the RFID tag. This portion of memory would include the device identification information as well as a file directory which can be changed as different files are updated, added or deleted from the files stored on the memory device.

In still another embodiment, in addition to using a first portion of memory for an RFID tag, it is contemplated that other memory devices are powered. For example, memory residing in a camera has power available since batteries power the camera. It is contemplated that in such applications the missing components of an RFID tag could be added to a memory device instead of attaching or electrically connecting a stand alone RFID tag to the memory device. It is contemplated that a coil and an antenna for receiving electromagnetic energy and sending RF having a modulated field representing data could be added to a memory device, in some instances, for lesser price than adding a stand alone RFID tag. In other words, since many external memory devices”, are already electronically fabricated devices with processors, such as digital signal processors, microcontrollers, and memory, with firmware, the addition of a stand alone RFID tag would be duplicative. In other words, the remaining parts for the “RFID” tag could be added to the external memory device. The electronic items needed for this process can be added or shared with the existing electronics already on external memory devices. It is contemplated that the additional parts needed to complete an RFID tag 320, 420 could be incorporated into the manufacturing process for the external memory device for an insignificant monetary amount. In addition, firmware for LUT's, password protection, and power saving strategies could also be programmed into memory as an instruction set for the digital signal processors, microcontrollers, and the like to execute.

The same is true for the RFID readers, similar to devices 310, 420 used in the keyboards, cell phones, music players and cameras. Many of these devices that could include a RFID reader already include a microcontrollers, microprocessor, and memory and firmware in them. The addition, during the manufacturing process, of the needed silicon to form the additional parts to form an RFID reader is thought to be of an insignificant amount.

The “RF” power on a “passive” device, such as “external memory devices”, more than likely cannot power-up the entire device and have a highly rated performance factor in the “RF” data communication during the “backscatter” routine. Therefore, power distribution for power savings should be done. As an example, the standard I/O for USB or SIM transmission would not have to be enabled on, using a field effect transistor (FET), during the “RF” process. Bank switching of the external memory devices memory would be another power saving item. Power FET's in the “external memory devices” could be used to switch on and off banks or all of the memory. With multiple FET's in this area, all could be turned on during normal USB transmission, or selected banks could be powered on and off during both the USB transmission and the “RF” period. Multiple banks would accommodate for the reading and writing of not only the “RF” memory, but also the normal memory of the “external memory devices” if enabled.

In some embodiments, enabling password protection should be incorporated. An owner of the external memory device may not want anybody else to access certain information on the external or portable memory device. Password protection could be enabled with a routine that can be activated as an option when the device is first initialized. No reading or writing to any memory associated with an RFID should be allowed without first doing initialization. All RF readers should be able to handle multiple passwords for different memory locations. In one embodiment, at least one memory area is considered as a general memory area on an external memory devices that does not require a password for reading or writing in the RF mode. This will make all external memory devices universally accepted by any RFID reader, such as RFID reader 320, 420 (shown in FIGS. 3 and 4 above).

In one embodiment, the software for the RFID reader can be minimized in that information from the RFID reader would not have to be routed to other offices or business sites and further manipulated. More than likely, the RFID reader is only querying the external memory device to detect the content on that particular device. The content information would merely need to be placed on a display for visually reading the contents. In another embodiment, the content information could be sent to a digital-to-analog converter for audio interpretation.

FIG. 5 is a schematic diagram showing an RFID tag 500, that includes a first tag portion 510 and a second tag portion 520, according to an example embodiment. It is contemplated that some RFID tags formed may have a first tag that operates as a standard tag and a second tag portion that allows for read write memory to be updated. In other words, the first tag can operate as a standard tag. For example, the first tag portion could act as a “class 1” “tag”. The “class 1” has a write once and read many type memory. The second tag portion would have a read write memory that could withstand many writes to the same memory locations. The writes could be content updates. It is also contemplated that this second tag portion might even operate at another RF range or frequency, such as at 13.56 MHz. When operating at this frequency, the RF tag must be relatively close to the RF reader. Standard RF readers operate at radio frequencies in the 915 MHz area. The first tag portion 510 could operate as a standard RFID tag. The second portion can access a portion of the main memory of the external memory or portable memory device. This second portion 520 would be password protected to prevent others from determining the contents of the portable memory to which is it communicatively coupled.

It is contemplated, that an external memory devices having an RFID tag portion 510 operating at 915 MHz embedded into their electronics, would no longer need a standard RFID tag or bar code affixed to a packaging container. So the cost, if RFID tag , such as tag 500, embedded with the current electronics on an external memory device would save the cost of an external RFID tag. In addition, cost savings would also be achieved because the traditional way of affixing an RFID tag would be eliminated. No additional human or machine interaction would be needed.

A cell phone can have a dual purpose. It should be both a RFID reader and a “tag”. It should be a RFID reader so that it can use “RFID” to read the 13.56 MHz information that “external memory devices” would want to output to a human for decision making It should also be a “class 1 tag” so that a computer can also read/write the contents of its “SIM” and its configuration. This would probably also operate at the 13.56 MHz frequency. The cell phone would be considered an “active tag” because of its battery, in this mode of operation, and therefore energy for powering-up the “SIM” for bi-directional data transmission would pose no problem.

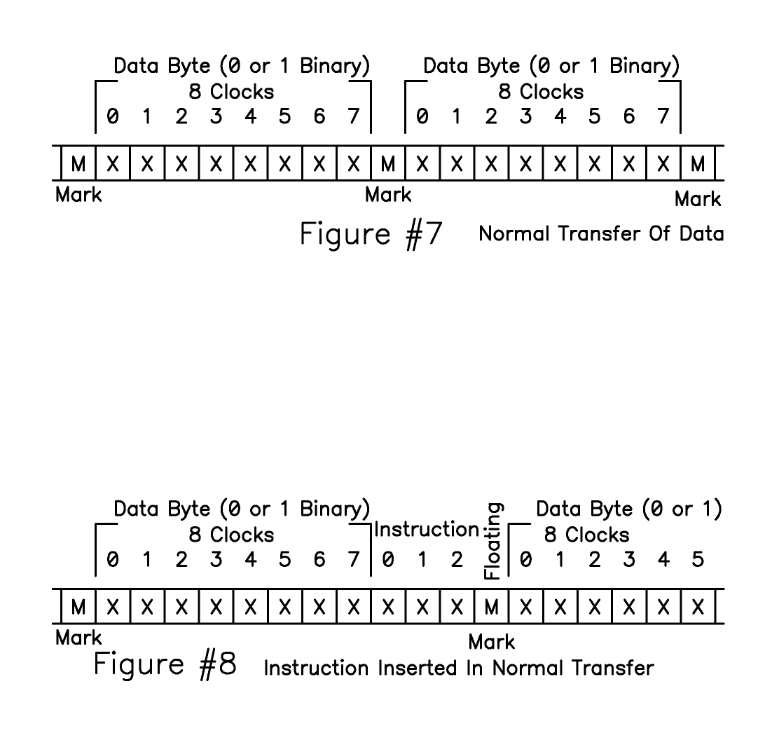

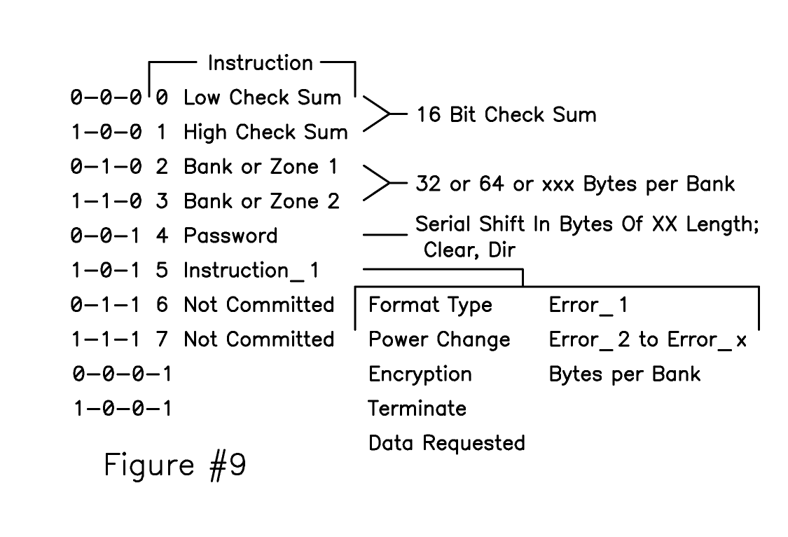

FIG. 6 is phase-shifted waveform, such as a modulated RF signal, with three possible choices for a mark bit for a phase lock loop AND/OR gate, according to an example embodiment. FIG. 7 is a diagram showing data transfer in eight byte segments between the timing marks, according to an example embodiment. FIG. 8 is a diagram showing data transfer in eight byte segments along with transfer of a three byte instruction between floating timing marks, according to an example embodiment FIG. 9 is an instruction and password set, according to an example embodiment.

Now referring to FIGS. 6-9, a serial input/output (I/O) for an RFID system will be further detailed. Both the RFID reader, such as reader 310 (shown in FIG. 3) and the external memory devices as an RFID tag 310, 410, 500 can use this example serial I/O scheme. In FIG. 7, an eight bit data transfer is shown for the normal exchange of ASCII data. A seven bit data transfer could also be employed for just normal alpha-numeric characters. The seven bit data transfer would save energy, especially for the RFID tag associated with an external memory device which is normally passive and which generally includes a write once, read many (WORM) memory.

FIG. 6 shows a phase-shifted scheme with three choices. The clocking edge can be a “0” or “1” or “Mark”. The “Mark” would denote the end of the shifting binary data. This is shown in FIG. 7 which is of eight bits. FIG. 7 could have been shown to accommodate only seven bits if that were the format for the device. FIG. 8 shows a floating “Mark” bit in which a three bit instruction has been added. The word “floating” has been used to indicate that this feature can be used anywhere in the midst of a data stream. It does not have to be just the beginning or an end of a data stream. By counting from “Mark” to “Mark”, both devices, the RFID reader and the external memory devices can decipher when a special group of bits has been sent and react to it or decode it.

As an example of use, imagine that an RFID reader device, before interrogating an external memory device, can do a spectrum analysis of the RF backscatter band frequency. Upon learning of the background noise in that “RF” range, the RFID reader can ask for a check sum at certain intervals in order to get the most rapid reading of the data and use the least amount of energy. That would include the rereading of some packets that were corrupted and only those packets, not the entire data stream.

This can also be used to send an instruction that the power is low on an external memory device and that the remaining data cannot be sent without an RF power boost. The RFID reader can re-send its “RF” energy and request that the transmission be continued but from packet number “xx”. This can be an energy saving scheme for the battery on the RFID reader of portable devices. Rather than a fixed cycle with xx bits of data, it can now be floating. The resulting power consumption will be less. Power consumption, it is contemplated, will continue to be a concern. As power consumption becomes more of a concern, this feature should also applicable and a benefit.

If the “external memory device” has built in 915 MHz “RF” “backscatter” capability, it can, with little design effort, be used to identify who you are in a security entrance system. As an example, the entrance into an indoor garage at a private residence or at a condominium or office. Using the normal plug, such as the USB or SIM, the external memory device would be programmed with who the RFID reader is and a set of randomly generated numbers, very possibly in the mega-bits. The external memory device would also be given a password of some length that is also stored in the RFID reader memory to match those random numbers. 13.56 MHz could also be used, but for shorter distances. The addition of this feature is mostly firmware, not the addition of memory.

Password protection will now be described using an example of a car entering a condominium complex. It should be pointed out, that the example can be used for any security situation. For example, at a condominium; a car would be sensed and the RFID reader would send out its RF signal as to the identification of the particular RFID reader. The external memory device would respond with whom it is, such as the password that corresponds with the particular RFID reader. The RFID reader would then respond with an address pointer, which could be a random pointer but not recently used, for xx bits of memory from the external memory device. If the external memory device is valid, it will respond with the correct number of bits in the correct order that match the RFID reader bits in memory. This scheme can accommodate multiple RFID readers with their own unique set of security numbers all on one external memory device.

In some embodiments, complexity can be added to the security memory with the addition of “hopping” algorithms. A “hopping” algorithm is a list of randomly generated numbers of xx length. When the RFID reader is generating the random numbers for the external memory device, it would also generate, as an example, 24 hopping algorithms that are, as an example, 36 numbers in length each and store them in both devices. The “hopping” algorithms would be numbered 1 to 24. Instead of the two systems, the RFID reader and the “external memory device”, picking a linear string of numbers, the selection would be that of the “hopping” algorithm with the start address pointer sent from the RFID reader. The RFID reader would also select which “hopping” algorithm to use. The start address pointer would not be the first bit sent; instead, the first bit sent is the start pointer address number plus or minus the first number from the “hopping” algorithm. If the asked for number of security bits exceed the length of the “hopping” algorithm, then the firmware in the “external memory device” and the RFID reader should roll-over the “hopping” algorithm.

The invention includes a system including at least one of hardware, software, firmware and electronics. In some instances, the invention includes hardware and software. The software can include firmware, which is software written for use by a device. Each memory device, such as a ‘jump drive’ or ‘SD’, is equipped with an RFID transmitter. The data that is being transmitted can also be written to and read from a hosting device, such as a computer, using a standard Universal Serial Bus (USB) type of connector. Hence, the RFID transmitted data does not have to be static. That is, it can be changed to represent meaningful information to the owner of the memory device as the contents of the main memory is changed or updated. Therefore, each memory device, such as a “jump drive”, “thumb drive” or “SD”, would actually have two units of memory. One unit of memory would be the main, or normal, larger memory. The other unit of memory would be a smaller unit of memory used for an RFID transmission. The same memory device could be partitioned into a smaller unit of memory and a larger unit of memory. In one embodiment, the amount of memory devoted to the smaller amount of memory as the first or smaller memory unit is the first four Kbytes used for RFID transmission. The size is an example. In other embodiments, the size of the first portion or smaller memory portion could be dynamic. Power to the two portions of memory, in one embodiment, would be distributed because of power consumption.

When operating in RFID mode, not all of the device memory would need power. With the RFID information being displayed, the owner of the memory device will probably better utilize more, if not all, of the memory on a given device.

Described above are some of several example embodiments. Although a few variations have been described and illustrated in detail above, it should be understood that various other modifications are not only contemplated but also possible. It should be noted that many other embodiments may be within the scope of the invention as defined by the claims section set forth below. A few of the variations to the example embodiments are listed below: The below listing is far from exhaustive and it should be pointed out that other variations in addition to those listed below are still considered within the scope of the invention.

1. A “Portable Storage Device” such as a “jump drive” or an “SD” memory device, that has additional memory so that it can be used as personal identification. As an example, if there were digital pictures, it could state where, when, who took the pictures. Whether the pictures should be saved for some amount of time. The receiving device could be a computer, cell phone, or a camera as an example.

As another example, if the memory device contained digital data about a business. The personal data could contain the date(s) and what the business data is about. It could include whether or not the data should be archived and for how long. In one embodiment, this small amount of memory probably would be in the order of Kbytes.

2. This small amount of memory (Kbytes) on the “Portable Storage Device” would have the ability to receive its power format least two sources. One source of power would be the same source that is powering the larger amount of memory (usually a number of Gigabytes or larger). This power source is typically through the connector, such as a “USB” connector. The second source of power would be that that is generated from an “RF” source such as being done with “RFID” tags. This second source of power, “RF”, does not have to power the larger amount of memory, which is usually in the order of a number of gigabytes or larger. The larger amount of memory would draw much more power. In another embodiment, this could be infrared also, see #15.

3. The small amount of memory (Kbytes) on the “Portable Storage Device” can be accessed from two different ways. If the “Portable Storage Device” is plugged into its normal connector, such as a “USB” connector, the small amount of memory can be both read and written to. The second way to communicate with the small amount of memory could be a “Read Only” path of communication or it could be a “Read/Write” path of communication. If the device has “Read/Write” capability, there must be an enable bit to set to allow for “Write” when the device is first used and plugged into the normal physical connector, such as a “USB”. This enable bit can be enabled or disabled when plugged into the normal physical connector. As shipped from the factory, this bit should be set to disable “Write” to thwart unwanted loading of the device while hanging on store shelves. The ‘RF’ energy can be pulsed to receive the data in packets if one pulse of ‘RF’ energy is insufficient to give the power needed for the memory data to be sent back.

4. The transmission of the small amount of memory (Kbytes) on the “Portable Storage Device” can be received for different ways of communication to the receiving device. The first way would be to display the digital data on a screen such as is found on a computer or cell phone, for example, so that a person or user can read the information. The second way would be to convert the digital information to audio for devices that may not have a screen or for the visually impaired, such as a phone. The third way would be that the digital data could control a mechanical and/or electrical device such as an alarm, switch, or LED's.

5. The small amount of memory (Kbytes) on the “Portable Storage Device” can send the “RF” data to the receiving device in the forms of packets, or pulsed. The first packet could contain the memory size along with other coded data for the communication link along with normal data. The last packet could have a “termination” code.

6. Both the “Portable Storage Device” and the receiving device could have an embossed area on them to identify a “match up” area. When the devices are in “match up”, the transmission range of the “RF” energy would be at the peak. This “match up” area could also supply an automatic on/off source of activation, a switch. These areas could also be color coded for ease of identification or use; they could also be a ‘logo’.

7. Sensing of the “targeted memory device” can be done with an oscillator circuit similar to what is used in roads to detect cars for stop lights. This circuit can sense when a device “comes into” or “leaves” the target area.

8. The “RFID” receiving device could be a cable such as a “USB” cable, a “smart” cable. One end of the cable would plug normally into a computer like device, the other end would house the “RFID” electronics and could also be a port expander so that at least one or more “Portable Storage Device” could also plug in. The “RFID” could in itself be a port in a “USB” type of connection not requiring a cable. A ‘radio button’ on the screen could activate the RF energy for some amount of time. This would allow older computers the ability to use this invention.

9. The receiving device could be a portable, battery powered, device with LED indicators and no LCD screen. An activate switch would be necessary in order to conserve energy. A device could also control switches such as is needed in entry ways. This could also convert ‘text’ data into vocal data (visually impaired). The receiving device could have a ‘small’ screen that scrolled the text.

10. The receiving device could be a monitor in a computer system and need not use a “USB” port for access with the operating system. The receiver does not have to be part of a “hub”. There should be a ‘logo’ target area for best reading and orientation; screen, keyboard, cable, tray (optional vocal data for visually impaired).

11. The received digital data, from the small amount of memory (Kbytes) on the “Portable Storage Device”, can be placed as text on a computer screen with interactive action with a computer “mouse”, hence the use of packets as a choice with “radio buttons” on the text window.

12. Shielding of the “RF” energy in the “Portable Storage Device” may be needed to protect the memory of both the small amount of memory (Kbytes) and the larger memory (usually in Gigabytes or larger). This shielding can be placed to utilize the “RF” energy into a wave guide for the both the receiving and transmitting “antenna” in the “Portable Storage Device” (the need for ‘target’ alignment emblems).

13. There could also be a portable reader that is powered with a battery, LCD, or transformer. This could be a ‘text to audio’, a larger screen, a small scrolling screen or any combination. This device could also have ‘touch’ sensitive screen for scrolling the text or buttons for human interaction.

14. Transmission of the ‘ID’ data should tell the receiving device about how the device is configured and at least how much memory and/or packets for transmission.

15. The memory device could also have a small solar cell to help boost power if the RFID memory is quite large. The computer, or cable, could have an LED in the target area. This could be similar to an infrared sensor (memory) and emitter (computer/cable). This could be “press” sensitive to enable the emitter to an “on” state.

16. Each time the memory device is plugged onto the normal connector, such as a ‘USB’ connector, the data message that is transmitted in the RFID mode should be displayed for the computer or device operator. Changes can then be made. When the memory device is plugged its normal connector, such as a “USB”, all “RF” activities such as the transmission and receiving on the memory device should be disabled. “RF” transmission should also stop; that way there will be no interference of the “special memory” used in the RFID data, the computer can read and write.

17. In the RFID information sent out by the external memory device, there can be a percentage of memory, or, how many ‘K’ bytes of memory is used and not used. This can be an automatically updated item done by the operating system whenever the external memory device is plugged in or out of its normal cable, such as the ‘USB’. This is similar to a “properties” feature.

18. A “rich text” should be used, including background color. This would aid in rapid decision making as to the “correct” memory device.

19. The memory device could have an embossed area, such as a triangle (not equal 60 degree angles) or such as a pentagon (not having equal 72 degree angles) that protruded in or out. The receiving device would have a matching embossed area but with the opposite protrusion. With a configuration such as that, there could be contact “pins” for power and signaling. The contact pins on the memory device should not have to be protected because when the device is not plugged into a connector, such as a USB, the memory device has no power. Hence, “RF” energy does not have to be the only means for the device to communicate. Communication can be direct contact.

20. The USB cable should not be the only way for communication. For example, there could be extra pins on the microprocessor in the CPU and/or with the electronic chip in a screen (such as the LCD screen) and/or a keyboard. This communication can still be serial, but, with its own format.

21. Each memory can have at least 1 byte that signals the receiving device how long the data will remain on the screen. This “byte” can be set and reset by the operator when the device is plugged into its normal connector (such as the USB connector). The reason for this is because some memory devices may have a large amount of data for the operator to read while other memory devices may only have a sentence or two. The software on the receiving side (example CPU) should be capable of overriding this. Also, collapsing the screen should also override this function. The introduction of a different memory device should also override this function. The intent here is so that the operator does not have to use the mouse to replace the screen with new or original data. The mouse, of course, should still have access to the “memory screen” as far as collapsing and/or closing and/or saving.

22. The memory used in the “RFID” transmission does not have to be a fixed amount. This memory could be a “fused link” and/or programmable amount of memory. The customer could be given “boundary amounts” so that the customer can create their own size of “RFID” memory. This would allow different amounts of data to be transmitted over the link between the RFID tag 320, 420 and the RFID reader 310, 410. The RFID reader 310, 410 could be

23. The frequency of the “RF” energy can also be used to identify the screen type so that an appropriate message and/or length of message can be sent by the “jump memory” device. As an example; an “RF” energy of 10.1 khz could be a small screen, with scrolling capability, so that the transmitted message is only 100 bytes; an “RF” energy of 11.1 khz could be a large screen such as a computer screen with mouse interaction, hence, a much longer message; an “RF” energy of 12.3 khz could be an analog/voice response.

24. A “push button” can be placed on the “jump memory” so that when the device is placed in the “RFID” range (paired up) the output code or data is not the normal “information data” but an encrypted code that could unlock a door, garage door, pass word (partial or full) to gain access into a device such as a computer.

25. An encrypted code could also be handled without a “push button”. The “RFID” transmission could also be encoded and/or frequency shifted so that when the “jump memory” receives this energy, it automatically sends out the correct response. As an example; an “RF” energy of 10.1 khz could be normal operation normal information data; an “RF” energy of 11.3 khz could be security operation and data; an “RF” energy of 12.5 khz could be password operation and data for a computer.

26. Loading or altering of “encrypted data” can be password protected by the owner of the “jump memory” device; this does not have to be activated.

27. In the event of a password being incorrect, a red LED can be used to signal a programmable wait period of time before the password can be tried again.

28. Secure device; the serial va of the normal connector, such as the USB, can be protected with a password using the “RF” for a prompt for that password. Without that password from the prompt, normal “USB” communication would not connected. To reinstate this operation, if a “jump memory” device is plugged into its normal connector, such as a “USB”, without first going through the “RFID” communication, it will not work or connect at all. With this extra security, if the device were to be lost or stolen, the information on the device could not be accessed by another party. This security aspect would be useful for military or other sensitive data. The codeword would be very secure. This security could also be used for personal pictures, or corporate data, such as trade secrets, or sensitive business data.

29. The mentioned above on a secure device, all or part or none of the device could be activated into this mode of operation. This could be controlled through address mapping.

30. A computer operating system runs a computer and executes a computerized method that includes sending an RF signal to an RFID tag associated with an external memory device. And eliciting and receiving an input from the external memory device that identifies the external device and a set of files stored on the external memory device, in response to the sent RF signal. The input received, namely the set of files stored on the external memory device is displayed on a display device. In one embodiment, the display is an audio display. Audio displays are used for conveying information to those that are visually impaired. The display could also be visual or even tactile. The signal that is sent may also be termed an interrogation. The computer or computing device sending the signal is sometimes also termed as an “interrogator” computer. The operating system be associated with any computer or computing device, such as a cell phone, a camera, a music player, a personal computer, and the like. The computer executing the computerized method can be any sized computer, including a personal computer, main frame computer, work station or enterprise sized computer. The computer can also be a network of computing devices, such as a wide area network, local network or the internet.

31. The set of files stored on the external memory is a file directory, in one example embodiment. The data can have any size. For example, an amount of data may be relatively large for audio or image data and can be small if the data is alphanumeric. The font sizes transmitted can also be selected from a number of multiple sizes; 1) audio; 2) small data for devices with small screen such as cell phones; 3) large data for devices with large screens such as a computer. Also, the human being can load into the multiple data areas whatever data they please, including screen text and background colors.

32. The computer operating system (of?) can include detecting an external memory device. The external memory device can includes an RFID tag, or parts of an RFID tag. In one embodiment, the external memory device includes an antenna which is communicatively coupled to a portion of memory associated with the memory device and a processor also associated with the memory device. The computer executing the computer operating system can include an RFID reader. The computer, in some instances, may only include an antennae. The antennae can be tied to memory and a microprocessor already associated with the computer.

33. A computer system includes a processor coupled to a communications and data bus, a memory coupled to the processor by way of the bus, and a display device for displaying selected information, the display also coupled to the bus. The computer system also includes an RFID reader coupled to the bus, an RF sending module for sending an RF signal to an external device; and an elicit and receive module for eliciting and receiving an input from the external device that identifies the external device and a set of files stored on the external device, in response to the sent RF signal. The computer system also includes a display module that displays the set of files associated with the external device on the display. As requested; which set of data memory. The external device identified can be a memory device, or can be a device that includes a memory.

In one embodiment, the RF sending module, the elicit and receive module, and the display module include an instruction set executable by the processor for causing the computer system to send an RF signal to an external device, and to elicit and receive an input from the external device that identifies the external device and a set of files stored on the external device. In response to the sent RF signal; and display the set of files associated with the external device on the display. A display communicates data and can be an audio or a visual display.

34. A machine-readable medium that provides instructions that, when executed by a machine, cause the machine to perform operations that include: sending an/a selected RF signal to an external device, eliciting and receiving an input from the external device that identifies the external device and a set of files stored on the external memory device, in response to the sent RF signal; and displaying the set of files from the external device on a display. The display can be any type of input output device which conveys information including a visual display, an audio display or the like. The machine-readable medium can provide further instructions that, when executed by a machine, further cause the machine to elicit and receive information related to parameters associated with the files. The parameters associated with the file includes the size of the file. The machine-readable medium can provide instructions that, when executed by a machine, further cause the machine to perform operations wherein the parameters associated with the file include the date the file was last modified. The machine-readable medium can also provide instructions that, when executed by a machine, further cause the machine to perform operations wherein the parameters associated with the file include the type of file.

Some external memory devices are provided with an enable “Write” bit that can be enabled or disabled when the device is plugged into a physical connector. This enable “Write” bit controls or allows writing to an external devices memory by way of the “RF” mode.

35. One aspect of an RFID device comprises; an external memory device having memory and microprocessor; and an antenna, wherein a portion of the external memory is used to store information used for RFID transmissions and wherein a portion of the microprocessor executes an instruction set related to the RFID device. The portion of the memory used to store information for RFID transmissions is a partition of the memory associated with the external memory device.

The foregoing discussion discloses and describes merely exemplary embodiments of the present inventions. Upon review of the specification, one skilled in the art will readily recognize from such discussion, and from the accompanying figures and claims, that various changes, modifications and variations can be made therein without departing from the spirit and scope of the invention as defined in the following claims.

1. A computer operating system that runs a computer, the computer operating system executing a computerized method comprising:
sending an RF signal to an RFID tag associated with an external memory device;
eliciting and receiving an input from the external memory device that identifies the external device and a set of files stored on the external memory device, in response to the sent RF signal; and
displaying the set of files on a display device.

2. The computer operating system of claim 1 wherein the step of displaying the set of files includes an audio display.

3. The computer operating system of claim 1 wherein the set of files stored on the external memory is a file directory.

4. The computer operating system of claim 1 further comprising detecting an external memory device.

5. The computer operating system of claim 1 wherein the external memory device includes an RFID tag.

6. The computer operating system of claim 5 wherein a computer executing the computer operating system includes an RFID reader.

7. A computer system comprising:
a processor coupled to a communications and data bus;
a memory coupled to the processor by way of the bus;
a display device for displaying selected information, the display coupled to the bus;
an RFID reader coupled to the bus;
an RF sending module for sending an RF signal to an external device;
an elicit and receive module for eliciting and receiving an input from the external device that identifies the external device and a set of files stored on the external device, in response to the sent RF signal; and
a display module that displays the set of files associated with the external device on the display.

8. The computer system of claim 7 wherein the external device is a memory device.

9. The computer system of claim 7 wherein the external device includes a memory.

10. The computer system of claim 7 wherein the RF sending module, the elicit and receive module, and the display module include an instruction set executable by the processor for causing the computer system to
send an RF signal to an external device;
elicit and receive an input from the external device that identifies the external device and a set of files stored on the external device, in response to the sent RF signal; and
display the set of files associated with the external device on the display. And/or audio. As requested; which set of data memory.

11. A machine-readable medium that provides instructions that, when executed by a machine, cause the machine to perform operations comprising:
sending an/a selected RF signal to an external device;
eliciting and receiving an input from the external device that identifies the external device and a set of files stored on the external memory device, in response to the sent RF signal; and
displaying the set of files from the external device on a visual display. And/or audio.

12. The machine-readable medium of claim 11 that provides instructions that, when executed by a machine, further cause the machine to elicit and receive information related to parameters associated with the files.

13. The machine-readable medium of claim 12 that provides instructions that, when executed by a machine, further cause the machine to perform operations wherein the parameters associated with the file includes the size of the file.

14. The machine-readable medium of claim 12 that provides instructions that, when executed by a machine, further cause the machine to perform operations wherein the parameters associated with the file includes the date the file was last modified.

15. The machine-readable medium of claim 12 that provides instructions that, when executed by a machine, further cause the machine to perform operations wherein the parameters associated with the file includes the type of file.

16. The machine readable medium of claim 12 that provides instructions to determine if a write enable bit is enabled on an external memory device, the instructions allowing external memory to be written to using RF transmissions in response to the enablement of the write enable bit.

17. An RFID device comprising:
an external memory device having memory and microprocessor;
an antenna, wherein a portion of the external memory is used to store information used for RFID transmissions and wherein a portion of the microprocessor executes an instruction set related to the RFID device.

18. The RFID device of claim 17 wherein the portion of the memory used to store information for RFID transmissions is a partition of the memory associated with the external memory device.
